(19) United States
(12) Patent Application Publication
(10) Pub. No.: US 2012/0230504 A1
(43) Pub. Date: Sep. 13, 2012

(54) NOISE-REDUCTION DEVICE

(75) Inventor: Kazuo Kuroda, Yokohama (JP)

(73) Assignee: PIONEER CORPORATION, Kawasaki-shi, Kanagawa (JP)

(21) Appl. No.: 13/395,227

(22) PCT Filed: Sep. 10, 2009
(86) PCT No.: PCT/JP2009/065811

§ 371 Date: May 24, 2012

(51) Int. Cl. G10K 11/16

(52) U.S. Cl. 381/71.4

(57) ABSTRACT

When cancelling noise by acoustically outputting, to a room interior, sound having a phase opposite to that of noise leaked into the room interior of a movable body, if detected movable body exterior sound is predetermined specific sound, a cancelling amount of a noise cancelling operation is automatically reduced.

### TECHNICAL FIELD

The present invention relates to a noise-reduction device, and in particular to a noise-reduction device for reducing noise leaked into a room of a movable body such as a vehicle from outside thereof.

### BACKGROUND ART

As a noise-reduction device, there is currently known a device for reducing noise by collecting (detecting) noise with a microphone and acoustically outputting sound having a phase opposite to that of a main noise component thereof so as to cancel out the noise and the antiphase noise (hereinafter, referred to as noise cancel) (see Patent Literature 1, for example).

If such a noise-reduction device is equipped in a vehicle, it is possible to obtain a pleasant car interior environment excluding various offensive noises leaked into the room of the vehicle from the outside thereof.

### CITATION LIST

### Patent Literature

Patent Literature 1: Japanese Patent Application Laid-Open No. 2009-17083

### SUMMARY OF INVENTION

### Technical Problem

However, there is a case where a driver determines a driving operation using vehicle exterior sound such as warning sound (specific sound) as an index. Thus, if the noise cancel as described above is performed under circumstances where such specific sound exists, it becomes difficult to hear the specific sound itself, too. The present invention has been made in order to solve such a problem, and an object thereof is to provide a noise-reduction device with which specific sound required as a driving index can be heard clearly.

### Solution To Problem

A noise-reduction device according to the present invention is a noise-reduction device for reducing noise in room interior of a movable body, and includes: a noise cancelling unit for acoustically outputting sound having a phase opposite to that of a main component of the noise to the room interior of the movable body so as to cancel the noise; a specific sound determination unit for determining whether or not predetermined specific sound has been emitted outside the movable body; and a control unit for reducing a noise cancelling amount in the noise cancelling unit in a case where it is determined in the specific sound determination unit that the specific sound has been emitted.

### BRIEF DESCRIPTION OF DRAWINGS

FIG. 1 is a diagram showing an example of an embodiment in which a noise-reduction device according to the present invention is equipped in a vehicle as a movable body.

FIG. 2 is a diagram showing an example of installed positions of room microphones 3A and 3B.

FIG. 3 is a diagram showing another example of installed positions of speakers 7A and 7B.

FIG. 4 is a block diagram showing an example of an internal configuration of a noise cancelling control unit 4.

FIG. 5 is a diagram showing an example of a memory map in an EPROM 25.

FIG. 6 is a chart showing a noise cancelling control flow.

FIG. 7 is a graph showing an example of frequency-level characteristics for an ambulance siren.

FIG. 8 is a chart showing an example of a road noise acquiring control flow.

FIG. 9 is a block diagram showing a configuration of a noise cancelling control unit in a second embodiment.

FIG. 10 is a block diagram showing a configuration of a noise cancelling control unit in a third embodiment.

### DESCRIPTION OF EMBODIMENTS

In a noise-reduction device according to the present invention, when cancelling noise by acoustically outputting sound having a phase opposite to that of noise leaked into room interior of a movable body, if detected movable body exterior sound is predetermined specific sound, a noise cancelling operation is automatically disabled or a cancelling amount is reduced while the specific sound is being detected. As a result, also in a case where specific sound required for safe driving, such as an emergency vehicles siren or railroad crossing sound, is emitted while the vehicle is running, a driver can hear that specific sound clearly.

Embodiments of the present invention will be described below with reference to the drawings. Note that constituent elements or parts substantially the same or equivalent to each other will be denoted by the same reference numerals or letters in the drawings to be described below.

### First Embodiment

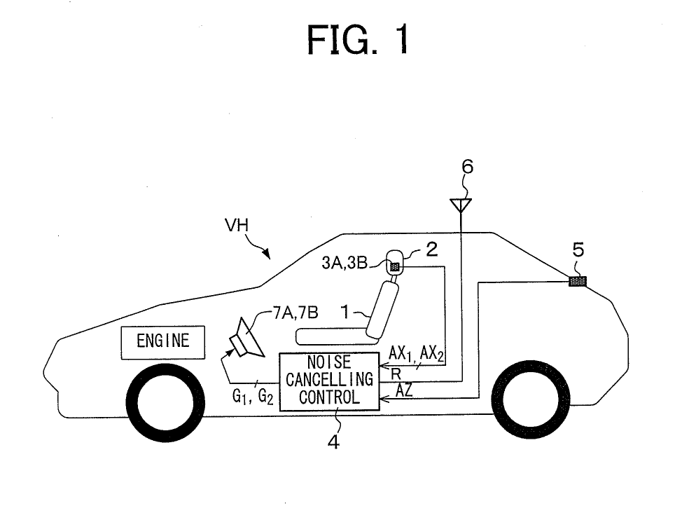

FIG. 1 is a diagram showing an example of an embodiment in which a noise-reduction device 10 according to the present invention is equipped in a vehicle VH as a movable body.

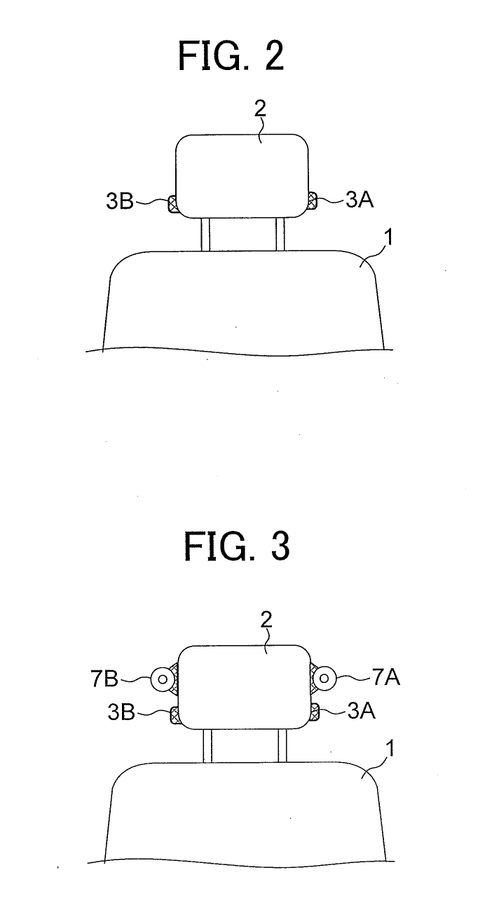

In FIG. 1, room microphones 3A and 3B for collecting (detecting) sound in the room interior of the vehicle (hereinafter, referred to simply as “vehicle interior” or “car interior”) are installed on a head restraint 2 placed at a driver's seat 1 in the vehicle VH. For example, the room microphones 3A and 3B are installed respectively at left and right sides of the head restraint 2 as shown in FIG. 2. The room microphones 3A and 3B provide signals obtained by detecting car interior sound at the respective installation positions to a noise cancelling control unit 4 as car interior sound signals AX₁ and AX₂. That is, the room microphone 3A provides, to the noise cancelling control unit 4, the car interior sound signal (or car interior sound detection signal) AX₁ obtained by detection in the vicinity of a left ear of a driver seated on the driver's seat 1. The room microphone 3B provides, to the noise cancelling control unit 4, the car interior sound signal AX₂ obtained by detection in the vicinity of a right ear of the driver.

An external microphone 5 for collecting (detecting) car exterior sound is installed at a rear side of the vehicle. As shown in FIG. 1, the external microphone 5 is installed at a position spaced apart from an engine with a predetermined distance or more in order not to pick up, as much as possible, sound or vibration of the engine as a power source for the vehicle. The external microphone 5 provides, to the noise cancelling control unit 4, a signal obtained by detecting car exterior sound as a car exterior sound signal (or car exterior sound detection signal) AZ.

An antenna 6 provides, to the noise cancelling control unit 4, a road information received signal R obtained by receiving road information wirelessly transmitted from another vehicle or a road information service center (not shown in the figure) as proposed by the ITS (Intelligent Transport Systems) Promotion Association, a nonprofit organization called ITS Japan, or the like.

As viewed from the driver seated on the driver's seat 1, speakers 7A and 7B are embedded and installed respectively into a left side panel and a right side panel (not shown in the figure) under a dashboard of the vehicle. The speakers 7A and 7B produce acoustic outputs toward the vehicle interior in accordance with antiphase car interior noise signals G₁ and G₂ provided from the noise cancelling control unit 4, respectively. Note that the speakers 7A and 7B may be installed on the left and right sides of the head restraint 2 together with the room microphones 3A and 3B as shown in FIG. 3, respectively.

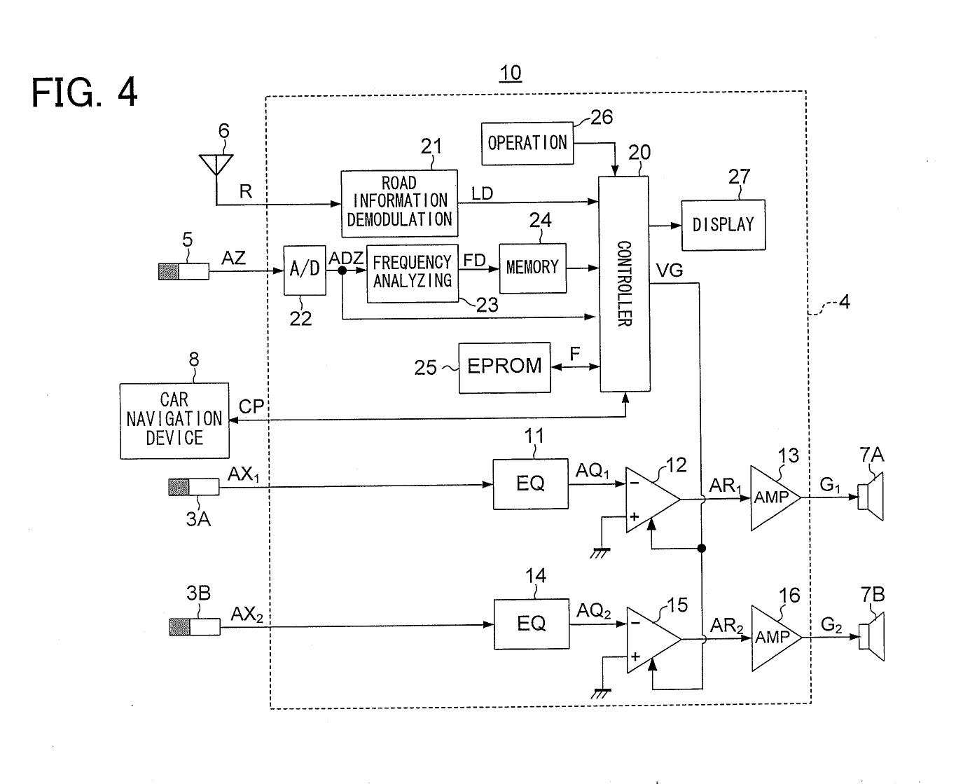

FIG. 4 is a diagram showing an example of an internal configuration of the noise cancelling control unit 4 in the noise-reduction device 10. The noise cancelling control unit 4 generates the antiphase car interior sound signals G₁ and G₂, respectively, based on the road information received signal R, the car exterior sound signal AZ, and the car interior sound signals AX₁ and AX₂, and provides them to the speakers 7A and 7B.

In FIG. 4, an equalizer (EQ) 11 extracts a signal in a frequency band of offensive noise such as road noise, wind noise, or engine noise from within the car interior sound signal AX₁ provided from the room microphone 3A, and provides it as a car interior noise signal AQ₁ to a variable gain inversion amplifier 12. The variable gain inversion amplifier 12 inverts a polarity of the car interior noise signal AQ₁ and provides, to an output amplifier 13, a signal obtained by amplifying the polarity-inverted car interior noise signal by a gain specified by a gain specification signal VG, as an antiphase car interior noise signal AR₁. The output amplifier 13 amplifies the antiphase car interior noise signal AR₁ to obtain the antiphase car interior noise signal G₁ capable of driving the speaker and provides the antiphase car interior noise signal G₁ to the speaker 7A.

An equalizer 14 extracts a signal in a frequency band of offensive noise such as road noise, wind noise, or engine noise from within the car interior sound signal AX₂ provided from the room microphone 3B, and provides it as a car interior noise signal AQ₂ to a variable gain inversion amplifier 15. The variable gain inversion amplifier 15 inverts a polarity of the car interior noise signal AQ₂ and provides, to an output amplifier 16, a signal obtained by amplifying the polarity-inverted car interior noise signal by a gain specified by the gain specification signal VG, as an antiphase car interior noise signal AR₂. The output amplifier 16 amplifies the antiphase car interior noise signal AR₂ to obtain the antiphase car interior noise signal G₂ capable of driving the speaker and provides the antiphase car interior noise signal G₂ to the speaker 7B.

A road information demodulation unit 21 demodulates road information data representing road information from within the road information received signal R received via the antenna 6, and provides it to a controller 20 as road information data LD.

An A/D converter 22 converts the car exterior sound signal AZ provided from the external microphone 5 to a digital signal, and provides the obtained digital car exterior sound signal ADZ to a frequency analyzing unit 23 and the controller 20. The frequency analyzing unit 23 performs fast Fourier transformation on the car exterior sound signal ADZ at predetermined measurement intervals, thereby generating car exterior sound frequency data FD as frequency spectra data representing power levels for respective frequencies. The frequency analyzing unit 23 provides the car exterior sound frequency data FD obtained at the predetermined measurement intervals to a memory 24. The memory 24 sequentially fetches and stores the car exterior sound frequency data FD generated at the predetermined measurement intervals, and reads out the car exterior sound frequency data FD in the fetched order and provides them to the controller 20.

A car navigation device 8 first detects a current position of the vehicle VH by utilizing the GPS (Global Positioning System), and specifies, based on the current position, a road the vehicle is currently running. Then, car positional information CP, each representing the name of the road, a type of the road (expressway, open road, forest road, or the like), a section of the road the vehicle is running at this point in time, the current position of the vehicle VH, or the like, is provided to the controller 20.

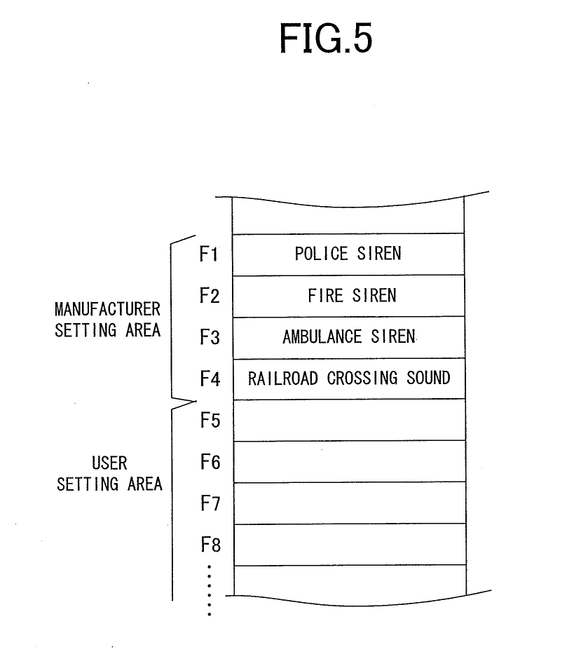

For each of various specific sounds required as a driving index, such as emergency vehicles sirens and railroad crossing sound, an EPROM (erasable programmable read-only memory) 25 stores specific sound frequency data F representing a frequency spectrum for the specific sound. The EPROM 25 includes a manufacturer setting area in which specific sound frequency data is stored in advance for each of various specific sounds prepared by the manufacturer, and a user setting area in which specific sound frequency data for each specific sound, which is generated (will be described later) in accordance with an instruction of the user, is stored as shown in FIG. 5, for example. In the manufacturer setting area of the EPROM 25, specific sound frequency data F1 to F4 respectively corresponding to a police siren, a fire siren, an ambulance siren, and railroad crossing sound are stored in advance as specific sounds as shown in FIG. 5, for example. Note that the specific sound frequency data F1 to F4 are obtained by performing by the manufacturer the fast Fourier transformation as in the above-described frequency analyzing unit 23 on each of the sirens and the railroad crossing sound as described above, and written in the EPROM 25 prior to the product shipment.

An operation unit 26 accepts various operations from a user, and provides, to the controller 20, an operation signal representing an operation instructed by the user's operation. For example, the operation unit 26 accepts an instructing operation for the start or stop of a noise cancelling operation, or an instructing operation for the start or stop of a road noise acquiring operation from a user, and provides an operation signal representing the instruction content to the controller 20. A display unit 27 displays an image represented by an image signal provided from the controller 20.

That is, the room microphones 3A and 3B, the equalizers (EQ) 11 and 14, and the variable gain inversion amplifiers 12 and 15 together form a noise cancelling unit. Moreover, the external microphone 5, the frequency analyzing unit 23, the memory 24, the EPROM 25, and the controller 20 together form a specific sound determination unit, and the controller 20 operates as a noise cancelling control unit.

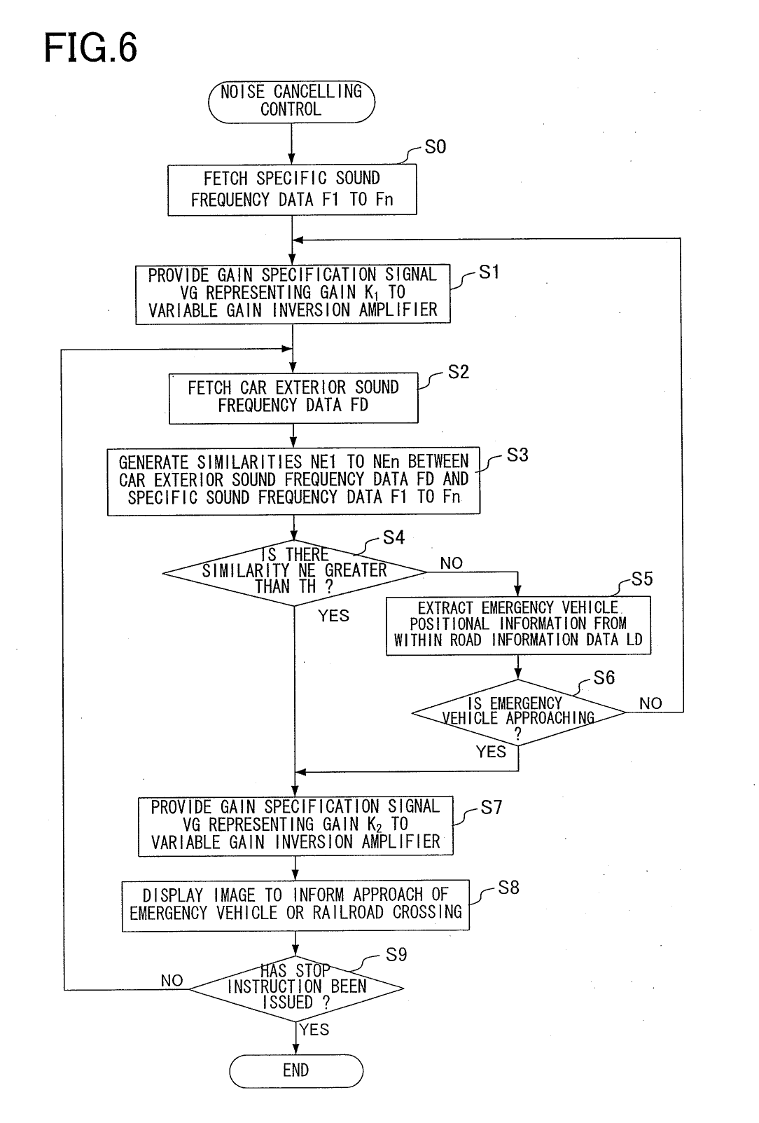

Next, a noise cancelling control operation performed by the controller 20 will be described with reference to a flow chart. The controller 20 executes a noise cancelling control routine shown in FIG. 6, for example.

In FIG. 6, the controller 20 first fetches all of the specific sound frequency data F1, F2, . . . , and Fn (Fj: j=1 to n) stored in the EPROM 25 (step S0). Next, the controller 20 provides the gain specification signal VG representing a gain K₁ respectively to the variable gain inversion amplifiers 12 and 15 in order to remove offensive noise leaked into the vehicle interior such as road noise, wind noise, or engine noise (step S1).

By the execution of step S1, the variable gain inversion amplifiers 12 and 15 invert a phase of the car interior noise signals (AQ₁ and AQ₂) detected in the vehicle interior, and send out, to the speakers (7A and 7B) via the output amplifiers (13 and 16), the antiphase car interior noise signals (AR₁ and AR₂) obtained by amplifying the phase-inverted car interior noise signals (AQ₁ and AQ₂) by the gain K₁. As a result, sound having a phase opposite to that of the noise leaked into the car interior (referred to as antiphase noise) is acoustically outputted from the speakers (7A and 7B) (noise cancel enabled). Then, this noise and the antiphase noise are cancelled out each other in the vehicle, and the noise aurally sensed by the driver is therefore cancelled.

Next, the controller 20 fetches the car exterior sound frequency data FD read out from the memory 24 (step S2). Next, the controller 20 obtains similarities between the car exterior sound frequency data FD and the previously fetched specific sound frequency data F1 to Fn, and generates corresponding similarities NE1, NE2, . . . , and NEn (NEj: j=1 to n) (step S3).

Note that the similarity NEj (j=1 to n) can be obtained by common various methods. For example, it can be obtained by performing intensity comparison (matching) for each frequency component in a frequency range (similarity zone) of the specific sound, or by various statistical methods including the calculation of a cross-correlation coefficient. That is, the specific sound frequency data F and the car exterior sound frequency data FD are those obtained by performing the Fourier transformation on audio signals corresponding to the sounds as described above. Here, the Fourier transformation represents an input signal by the superposition of various sine and cosine waves. In the Fourier transformation, an entire frequency band is divided into a plurality of bands (divided bands) and a level for each of the divided bands is detected by a bandpass filter at the center of the frequency so as to measure the level for each of the divided bands. Specifically, when a bandpass filter in the band of ±25 Hz is used, what level of sound exists in a range of a 50 Hz width for each of 50 Hz, 100 Hz, 150 Hz, . . . , which are centers of the divided bands, is measured.

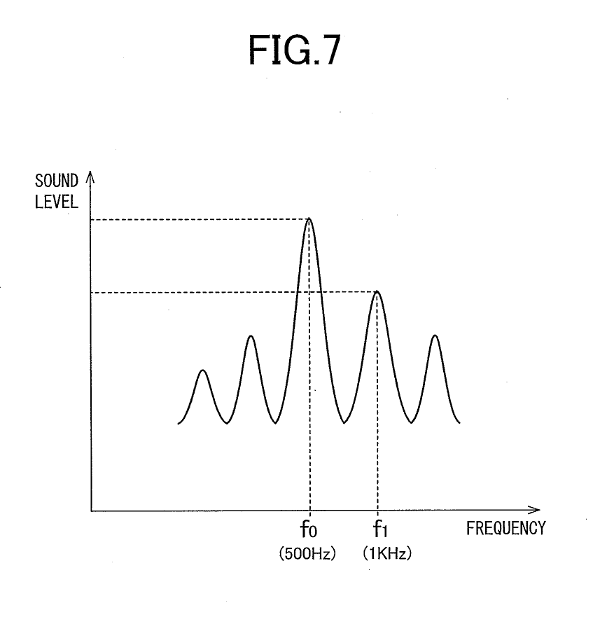

FIG. 7 is a graph showing an example of frequency-level characteristics for an ambulance siren.

As shown in FIG. 7, in the case of an ambulance siren, a frequency f0 at which the level thereof reaches its maximum is 500 Hz. Thus, in the A/D converter 22, it is necessary to perform sampling with at least the twofold frequency 1 KHz, typically with the fourfold frequency. In reality, since a signal in abroad frequency band is detected, sampling is performed with 48 KHz or 96 KHz. Here, the controller 20 detects the frequency f0 at which the level thereof reaches its maximum and the level at the frequency f0 for the car exterior sound frequency data FD obtained by performing the Fourier transformation by the frequency analyzing unit 23. Furthermore, the controller 20 detects a movement of a harmonic thereof. For example, in FIG. 7, the controller 20 detects a frequency f1, which is a harmonic twice as large as the frequency f0 (500 Hz) at which the level thereof reaches its maximum, and a level at the frequency f1. Then, the controller 20 checks the detected result against the data stored in advance in the EPROM 25 to obtain a similarity with each specific sound. Thus, it becomes possible to determine whether or not it is an emergency vehicles siren. Note that it can be determined that it is an emergency vehicles siren when a level difference between the above-described level at the frequency f0 and the level at the frequency f1, which is the second harmonic, is greater than or equal to a predetermined level. Furthermore, if the frequency f0 transitioned over time in such a way of 450→500→500 Hz, for example, it is possible to determine that an ambulance is coming closer and then continuously moving away.

Next, the controller 20 determines whether or not there is a similarity greater than a predetermined threshold TH among the similarities NE1 to NEn (step S4). That is, whether or not the vehicle exterior sound detected by the external microphone matches one of the various specific sounds (emergency vehicles sirens, railroad crossing sound, and the like as shown in FIG. 5, for example) represented by the specific sound frequency data F1 to Fn stored in the EPROM 25 is determined in step S4. If it is determined in step S4 that there is no similarity NE greater than the predetermined threshold TH, i.e., if it is determined that the vehicle exterior sound does not match any of the various specific sounds as shown in FIG. 5, and if a road specific service is available, the controller 20 extracts an emergency vehicle positional information indicating the current position of a moving emergency vehicle (including information indicating the name of the road the vehicle is running) from within the road information data LD (step S5). Next, based on the car positional information CP provided from the car navigation device 8 equipped in the vehicle and the above-described emergency vehicle positional information, the controller 20 determines whether or not there exists an emergency vehicle approaching one's own vehicle with a distance therebetween less than a predetermined distance on the road same as that on which one's own vehicle is running (step S6). If it is determined in this step S6 that there is no emergency vehicle approaching one's own vehicle, the controller 20 returns to the execution of the above-described step S1 to repeatedly execute the operation as described above. That is, if it is determined that the exterior sound detected by the external microphone does not match specific sound such as an emergency vehicles siren or railroad crossing sound (step S4), or if it is determined that there is no emergency vehicle approaching one's own vehicle based on the received road information data (step S6), the noise cancelling operation is continuously enabled.

On the other hand, if it is determined in step S4 that there exists a similarity NE greater than the predetermined threshold TH, i.e., if it is determined that the exterior sound detected by the external microphone is specific sound such as an emergency vehicles siren or railroad crossing sound, or if it is determined in step S6 that there exists an emergency vehicle approaching one's own vehicle, the following step S7 is executed. That is, if it is determined in step S4 that specific sound to be a driving index has been emitted outside the vehicle, the controller 20 provides the gain specification signal VG representing a gain K₂, which is smaller than the above-described gain K₁, to the variable gain inversion amplifiers 12 and 15 (step S7).

By the execution of step S7, the variable gain inversion amplifiers 12 and 15 respectively amplify the phase-inverted signals of the car interior noise signals AQ₁ and AQ₂ with the gain K₂ representing an amplification factor smaller than the above-described gain K₁. As a result, a level of antiphase noise acoustically outputted from the speakers 7A and 7B is reduced as compared to a level of the noise leaked into the car interior, thereby reducing a cancelling amount against the noise by an amount corresponding to the level reduction. Note that the gain specification signal VG, indicating gain “0” (zero) as the gain K₂, may be provided to the variable gain inversion amplifiers 12 and 15 in step S7. In other words, if it is determined that the detected car exterior sound matches one of the various specific sounds (FIG. 5) required as a driving index, or if the approach of an emergency vehicle is detected by an emergency vehicle information acquired from another vehicle with a vehicle-to-vehicle communication function suggested by the ITS, the noise cancelling operation is forcibly disabled. As a result, the driver is allowed to hear the specific sound easily.

After the execution of step S7, the controller 20 provides, to the display unit 27, an image signal for displaying an image to inform the approach of an emergency vehicle (or a railroad crossing) (step S8). By the execution of step S8, the display unit 27 displays a character image to inform the approach of an emergency vehicle or a railroad crossing, or a dynamic picture image of an emergency vehicle or a railroad crossing. Note that if it is determined in the above-described step S4 that the exterior sound is railroad crossing sound, the controller 20 may provide railroad crossing closed information, indicating that the first railroad crossing to be passed through in the moving direction of one's own vehicle is being closed, to the car navigation device 8 in this step S8. In this case, on a map being displayed currently, the car navigation device 8 changes a mark of the railroad crossing to be passed through first in the moving direction of one's own vehicle to a mark (for example, blinking display) indicating that it is being closed. Furthermore, during that time, the car navigation device 8 may acoustically output railroad crossing sound.

After the execution of such step S8, the controller 20 determines whether or not a stop instructing operation to stop noise cancelling control has been conducted by the user (step S9). If it is determined in step S9 that the stop operation has not been conducted, the controller 20 returns to the execution of the above-described step S2 to repeatedly execute the above-described operation. On the other hand, if it is determined that the stop operation has been conducted, the controller 20 discontinues the noise cancelling control routine as shown in FIG. 6. Thus, the noise cancelling operation is ended.

As described above, when cancelling noise by acoustically outputting sound having a phase opposite to that of the main component of the noise leaked into the vehicle interior, in a case where the detected vehicle exterior sound is predetermined specific sound or in a case where the approach of an emergency vehicle emitting specific sound is detected, the noise-reduction device 10 shown in FIG. 1 automatically disables the noise cancelling operation over the duration of such detection. As a result, also in a case where specific sound required as a driving index, such as an emergency vehicles siren or railroad crossing sound, is emitted while the vehicle is running, the driver can hear that specific sound clearly. Moreover, according to the above-described configuration and operation, even in a case where the driver listens to music, radio sound, or the like, with an audio device in a system different from that of the noise-reduction device 10, e.g., a car audio device, the driver can hear the specific sound clearly without lowering the volume of the audio device.

Note that while the gains of the variable gain inversion amplifiers 12 and 15 are switched between two levels, the gain K₁ (noise cancel enabled) and the gain K₂ (noise cancel disabled) in the noise cancelling control unit 4 shown in FIG. 4, the noise cancelling amount may be adjusted by changing the gain value in conformity with the magnitude of the specific sound recognized in the vehicle interior. That is, the controller 20 extracts an emergency vehicles siren from within the car exterior signal ADZ detected by the external microphone, and detects the magnitude of the sound. Then, the controller 20 executes, instead of step S7 shown in FIG. 6, control for reducing the noise cancelling amount by providing, to the variable gain inversion amplifiers 12 and 15, the gain specification signal VG which specifies a smaller gain as the emergency vehicles siren decreases. According to such control, as the emergency vehicles siren recognized in the car interior gets smaller, the noise cancelling amount also gets smaller. Thus, it becomes possible to constantly enable the noise cancelling operation to the extent that the driver can hear the emergency vehicles siren.

Moreover, although the noise cancelling control unit 4 shown in FIG. 4 stores specific sound frequency analysis data in the EPROM 25 in order to determine whether or not the detected exterior sound is the specific sound as described above, specific sound waveform data may be alternatively stored in the EPROM 25. In a case where such a configuration is employed, a similarity between a waveform of the detected exterior sound and waveforms of the specific sounds stored in the EPROM 25 is obtained so as to determine whether or not the detected exterior sound is specific sound.

Here, although an emergency vehicles siren or railroad crossing sound as specific sound varies from country to country, for example, a rewritable recording medium such as an EPROM is employed as a storage medium to store the specific sounds in the noise cancelling control unit 4 shown in FIG. 4. Thus, for each country, if specific sounds specific to that country are written thereto, it is possible to provide products corresponding to each country. Moreover, by employing an EPROM as a storage medium to store the specific sounds, it becomes possible to deal with a newly-added emergency vehicles siren.

Moreover, although it is determined whether or not a frequency component distribution stored in advance in the EPROM 25 matches a frequency component distribution of the sound inputted by the microphone in the above-described embodiment, in the case of a car, an SN ratio may possibly be reduced especially when the siren is heard distantly due to an influence of road noise or the like during the running thereof. In such a case, for each type of cars, road noise frequency components for respective speeds when having the vehicle run are stored in advance in the EPROM 25; a road noise frequency component corresponding to the current running speed is read out while the vehicle is running; and the road noise frequency component distribution is subtracted from the actually detected sound. As a result, it is possible to suppress a reduction in the SN ratio.

Moreover, in the case of sound which is not stored in the EPROM 25 and has an excessive sound volume, there is a possibility that an unexpected accident, or the like, has occurred nearby. In such a case, it is effective to reduce the noise cancelling effect.

Moreover, while the specific sound frequency data F corresponding to the specific sounds are stored in advance in the EPROM 25 in the above-described embodiment, specific sound emitted outside while the vehicle is running may be collected and the specific sound frequency data F corresponding to this specific sound may be generated at the noise cancelling control unit 4 and stored in the EPROM 25. Then, road noise during the running may be measured, and a road noise measurement information obtained by associating information indicating the type of the road during the running (for example, expressway, open road, forest road, or the like) with the measured road noise may be stored in the EPROM 25.

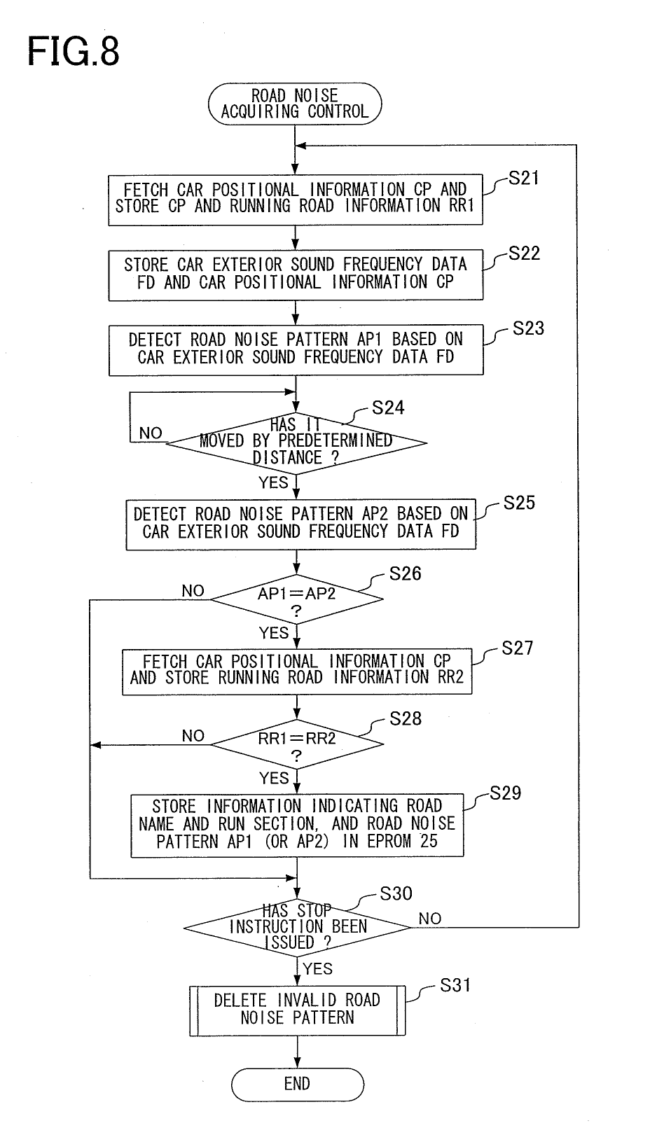

FIG. 8 is a chart showing an example of a road noise acquiring control flow for collecting specific sound emitted outside during the actual vehicle running; generating the specific sound frequency data F corresponding to the collected specific sound and generating the road noise measurement information indicating the road noise measured on the road the vehicle is currently running; and storing both of the data and the information in the EPROM 35 as described above.

First, the controller 20 fetches the car positional information CP provided by the navigation device 8, stores it in a built-in memory (not shown in the figure), and stores a running road information RR1 indicating the road the vehicle HV is currently running, which is indicated by the car positional information CP, in the built-in memory (step S21). Next, the controller 20 fetches the car exterior sound frequency data FD obtained by performing the Fourier transformation by the frequency analyzing unit 23 on the car exterior signal ADZ obtained by collecting sound by the external microphone 5 as of this moment, associates the car exterior sound frequency data FD with the above-described car positional information CP, and stores it in the built-in memory (step S22). Next, the controller 20 detects a car exterior road noise pattern based on the car exterior sound frequency data FD, and stores the pattern in the built-in memory as a road noise pattern AP1 (step S23). Next, the controller 20 repeatedly executes a determination whether or not the vehicle HV has moved by a predetermined distance from the execution point of the above-described step S23 based on the car positional information CP until it is determined that the vehicle has moved by the predetermined distance (step S24). Next, the controller 20 detects a car exterior sound periodic pattern based on the car exterior sound frequency data FD, and stores the pattern in the built-in memory as a road noise pattern AP2 (step S25). Next, the controller 20 determines whether or not the road noise pattern AP2 is identical to the above-described road noise pattern AP1 (step S26). In a case where it is determined that the road noise patterns AP1 and AP2 are identical to each other in step S26, the controller 20 stores, in the built-in memory, a running road information RR2 indicating the road the vehicle HV is currently running, which is indicated by the car positional information CP provided by the navigation device 8 (step S27). Next, the controller 20 determines whether or not the running road information RR2 is identical to the above-described running road information RR1 (step S28). In a case where it is determined that the running road information RR1 is identical to the running road information RR2 in step S28, the controller 20 stores the road noise pattern AP1 (or AP2) in the EPROM 25 in association with information indicating the name of the road and a section of the road the vehicle is running at this point in time, which are indicated by the above-described car positional information CP (step S29). That is, by the execution of the above-described steps S23 to S29, only if a road noise pattern maintains a certain condition while the vehicle HV is moving for a predetermined distance on a single road, this road noise pattern and the information indicating the road and the section of the road the vehicle is running are associated with each other and stored in the EPROM 25. After the execution of the above-described step S29 or in a case where it is determined that the road noise patterns AP1 and AP2 are different from each other in the above-described step S26 or in a case where it is determined that the running road information RR1 is different from the running road information RR2 in the above-described step S28, the controller 20 determines whether or not an operation signal for representing an instructing operation for the stop of road noise acquiring control has been provided by the operation unit 26 (step S30). If it is determined in step S30 that the operation signal for representing an instructing operation for the stop of road noise acquiring control has not been provided, the controller 20 returns to the execution of the above-described step S21, and repeatedly executes the operation as described above. On the other hand, if it is determined in step S30 that the operation signal for representing an instructing operation for the stop of road noise acquiring control has been provided, the controller 20 transitions to the execution of an invalid road noise pattern deletion routine (step S31). That is, in the invalid road noise pattern deletion routine, the controller 20 deletes, from among the road noise patterns which have been stored until now in the EPROM 25, a pattern with an appearance frequency lower than or equal to a predetermined frequency (once a month, for example), or a pattern whose appearance frequency order from the top is lower than a predetermined order (20th, for example). Then, after the execution of the invalid road noise pattern deletion routine by such step S31, the controller 20 discontinues the road noise acquiring control routine as shown in FIG. 8. Thus, the road noise acquiring operation is ended.

As described above, in a case where specific sound such as warning sound due to the approach of an emergency vehicle is detected, the noise cancelling operation is automatically disabled, or an adjustment to reduce the noise cancelling amount is performed to the extent that a driver can hear the specific sound. Thus, the driver can hear the specific sound clearly. Moreover, without lowering the volume of music, radio sound, or the like, being played by an audio device different from the noise-reduction device 10, e.g., a car audio device, the driver can hear the specific sound. That is, with no concern for the volume of the audio device, the driver can recognize the approach of an emergency vehicle or the like while listening to the outputted sound.

In the noise cancelling control unit 4 (FIG. 4) of the above-described first embodiment, the speakers 7A and 7B for acoustically outputting antiphase noise to the vehicle interior are provided separately from a speaker for acoustically outputting reproduced sound by the car audio device. However, the speaker of the car audio device in a system different from that of the above-described noise-reduction device 10 may be used to superimpose the above-described antiphase noise on the reproduced sound and produce an acoustic output thereof.

### Second Embodiment

In the second embodiment, a description will be given of a configuration with which noise cancel can be performed more accurately in a case where a speaker of a car audio device is used to superimpose the above-described antiphase noise on reproduced sound and produce an acoustic output thereof.

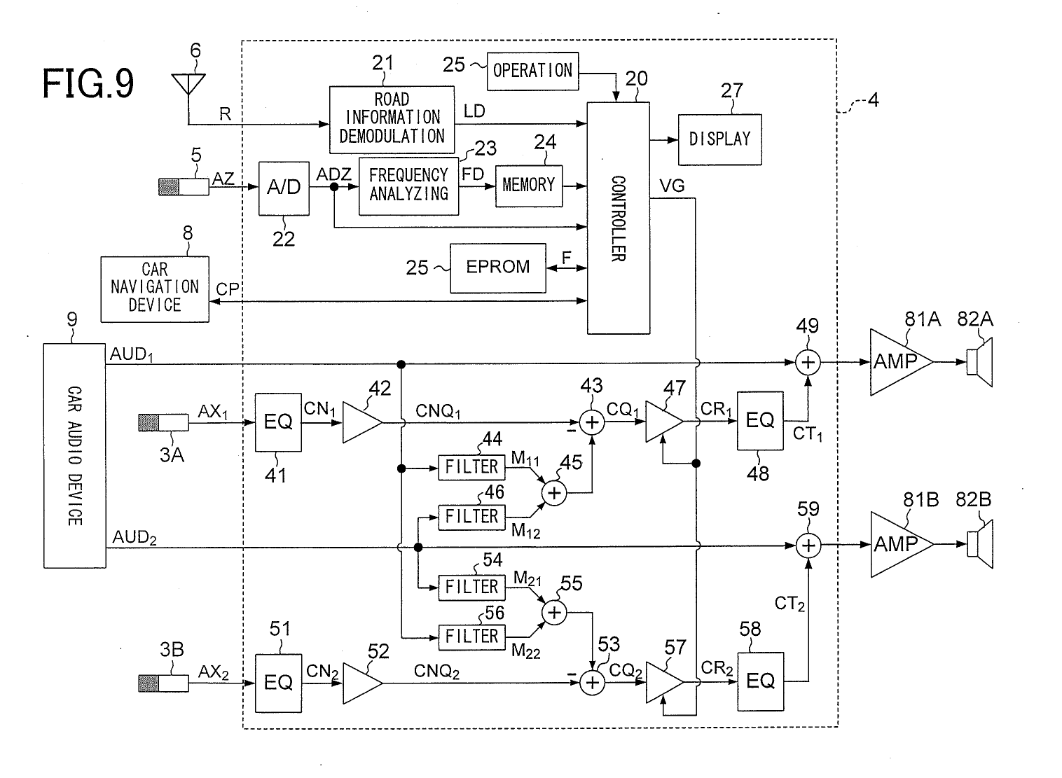

FIG. 9 is a block diagram showing a configuration of a noise cancelling control unit 4 in the second embodiment. As shown in FIG. 9, the noise cancelling control unit 4 is connected to a car audio device 9 equipped in a vehicle, in addition to room microphones 3A and 3B, an external microphone 5, and an antenna 6. The car audio device 9 reproduces audio signals representing music or conversational speech recorded on a CD (compact disc), a DVD (Digital Versatile Disc), a semiconductor memory, a magnetic disc, or the like, or demodulates audio signals representing music or conversational speech in broadcast waves (radio or television). The car audio device 9 provides, to the noise cancelling control unit 4, those of the reproduced or demodulated audio signals corresponding to a right channel, for example, as audio signals AUD₁, and those corresponding to a left channel as audio signals AUD₂. Note that the car audio device 9 includes: an amplifier 81A for amplifying the audio signal corresponding to the right channel; a speaker 82A for acoustically outputting the audio signal amplified by the amplifier 81A; an amplifier 81B for amplifying the audio signal corresponding to the left channel; and a speaker 82B for acoustically outputting the audio signal amplified by the amplifier 81B as shown in FIG. 9.

In the noise cancelling control unit 4 shown in FIG. 9, a road information demodulation unit 21, an A/D converter 22, a frequency analyzing unit 23, a memory 24, an EPROM 25, an operation unit 26, a display unit 27, and a controller 20 perform the same operations as those of modules denoted by the same reference numerals in FIG. 4. Thus, the operations of these modules will not be described.

In FIG. 9, an equalizer 41 extracts a signal in a frequency band of offensive noise such as road noise, wind noise, or engine noise from within the car interior sound signal AX₁ provided from the room microphone 3A, and provides the signal as a car interior noise signal CN₁ to an amplifier 42. The amplifier 42 provides a car interior noise signal CNQ₁ obtained by the amplification of the car interior noise signal CN₁ to an adder 43.

A filter 44 provides as a first leak-in audio signal M₁₁, town adder 45, a signal obtained by performing a filtering process based on predetermined first transmission characteristics on the audio signal AUD₁ provided by the car audio device 9. Here, the first transmission characteristics are those in a transmission channel assumed to be a range where the sound acoustically outputted from the speaker 82A transmits until it enters into the room microphone 3A. That is, the sound acoustically outputted from the speaker 82A enters into the room microphone 3A and the filter 44 thereby obtains the audio signal component (M₁₁) leaked into the above-described car interior noise signal CNQ₁ based on the audio signal AUD₁ reproduced or demodulated by the car audio device 9.

A filter 46 provides as a second leak-in audio signal M₁₂, to the adder 45, a signal obtained by performing a filtering process based on predetermined second transmission characteristics on the audio signal AUD₂ provided by the car audio device 9. Here, the second transmission characteristics are those in a transmission channel assumed to be a range where the sound acoustically outputted from the speaker 82B transmits until it enters into the room microphone 3A. That is, the sound acoustically outputted from the speaker 82B enters into the room microphone 3A and the filter 46 thereby obtains the audio signal component (N₁₂) leaked into the above-described car interior noise signal CNQ₁ based on the audio signal AUD₂ reproduced or demodulated by the car audio device 9.

The adder 45 provides, to the adder 43, a leak-in audio signal (M₁₁+M₁₂) obtained by adding the above-described first leak-in audio signal M₁₁ and the second leak-in audio signal M₁₂. The adder 43 provides as an antiphase car interior noise signal CQ₁, to a variable gain amplifier 47, the addition result of the leak-in audio signal (M₁₁+M₁₂) and a signal obtained by inverting a polarity of the car interior noise signal CNQ₁. That is, the adder 43 outputs the signal obtained by inverting a polarity of the car interior noise signal CNQ₁ as the antiphase car interior noise signal CQ₁ while removing the audio signal component (M₁₁+M₁₂) leaked into the car interior noise signal CNQ₁ due to the entering of the sounds acoustically outputted from the speakers 82A and 82B into the room microphone 3A.

The variable gain amplifier 47 provides as an antiphase car interior noise signal CR₁, to an equalizer 48, a signal obtained by amplifying the antiphase car interior noise signal CQ₁ by a gain indicated by the gain specification signal VG provided by the controller 20. The equalizer 48 extracts a signal in a frequency band of noise such as road noise, wind noise, or engine noise from within the antiphase car interior noise signal CR₁, and provides it to an adder 49 as an antiphase car interior noise signal CT₁. The adder 49 provides, to the amplifier 81A, an audio signal obtained by superimposing the antiphase car interior noise signal CT₁ on the audio signal AUD₁ reproduced or demodulated by the car audio device 9. The amplifier 81A amplifies such an audio signal to obtain an audio signal capable of driving the speaker, and provides the amplified signal to the speaker 82A. As a result, the speaker 82A acoustically outputs, to the vehicle interior, the sound obtained by superimposing the antiphase noise obtained by inverting a phase of the noise leaked into the vehicle interior on music or sound reproduced or demodulated by the car audio device 9.

An equalizer 51 extracts a signal in a frequency band of offensive noise such as road noise, wind noise, or engine noise from within the car interior sound signal AX₂ provided from the room microphone 3B, and provides the signal to an amplifier 52 as a car interior noise signal CN₂. The amplifier 52 provides, to an adder 53, a car interior noise signal CNQ₂ obtained by the amplification of the car interior noise signal CN₂.

A filter 54 provides as a first leak-in audio signal M₂₁, to an adder 55, a signal obtained by performing a filtering process based on predetermined third transmission characteristics on the audio signal AUD₂ provided by the car audio device 9. Here, the third transmission characteristics are those in a transmission channel assumed to be a range where the sound acoustically outputted from the speaker 82B transmits until it enters into the room microphone 3B. That is, the sound acoustically outputted from the speaker 82₂ enters into the room microphone 3B and the filter 54 thereby obtains the audio signal component (M₂₁) leaked into the above-described car interior noise signal CNQ₂ based on the audio signal AUD₂ reproduced or demodulated by the car audio device 9.

A filter 56 provides as a second leak-in audio signal M₂₂, to the adder 55, a signal obtained by performing a filtering process based on predetermined fourth transmission characteristics on the audio signal AUD₁ provided by the car audio device 9. Here, the fourth transmission characteristics are those in a transmission channel assumed to be a range where the sound acoustically outputted from the speaker 82A transmits until it enters into the room microphone 3B. That is, the sound acoustically outputted from the speaker 82A enters into the room microphone 3B and the filter 56 thereby obtains the audio signal component (M₂₂) leaked into the above-described car interior noise signal CNQ₂ based on the audio signal AUD₁ reproduced or demodulated by the car audio device 9.

The adder 55 provides, to the adder 53, a leak-in audio signal (M₂₁+M₂₂) obtained by adding the above-described first leak-in audio signal M₂₁ and the second leak-in audio signal M₂₂. The adder 53 provides as an antiphase car interior noise signal CQ₂, to a variable gain amplifier 57, the addition result of the leak-in audio signal (M₂₁+M₂₂) and a signal obtained by inverting a polarity of the car interior noise signal CNQ₂. That is, the adder 53 outputs the signal obtained by inverting the polarity of the car interior noise signal CNQ₂ as the antiphase car interior noise signal CQ₂ while removing the audio signal component (M₂₁+M₂₂) leaked into the car interior noise signal CNQ₂ due to the entering of the sound acoustically outputted from the speakers 82A and 82B into the room microphone 3B.

The variable gain amplifier 57 provides as an antiphase car interior noise signal CR₂, to an equalizer 58, a signal obtained by amplifying the antiphase car interior noise signal CQ₂ by a gain indicated by the gain specification signal VG provided by the controller 20. The equalizer 58 extracts a signal in a frequency band of noise such as road noise, wind noise, or engine noise from within the antiphase car interior noise signal CR₂, and provides it to an adder 59 as an antiphase car interior noise signal CT₂. The adder 59 provides, to the amplifier 81B, an audio signal obtained by superimposing the antiphase car interior noise signal CT₂ on the audio signal AUD₂ reproduced or demodulated by the car audio device 9. The amplifier 81B amplifies such an audio signal to obtain an audio signal capable of driving the speaker, and provides the amplified signal to the speaker 82B. As a result, the speaker 82B acoustically outputs, to the vehicle interior, the sound obtained by superimposing the antiphase noise obtained by inverting a phase of the noise leaked into the vehicle interior on music or sound reproduced or demodulated by the car audio device 9.

Therefore, according to the noise cancelling control unit 4 shown in FIG. 9, it is possible to eliminate offensive noise such as road noise, wind noise, or engine noise leaked into the vehicle interior while acoustically outputting, to the vehicle interior, music or sound reproduced or demodulated by the car audio device 9.

Here, in the noise cancelling control unit 4 shown in FIG. 9, the filters 44, 46, 54, and 56, and the adders 43, 45, 53, and 55 are provided in order to prevent a reduction in noise cancelling effect caused by the detection of music or sound acoustically outputted by the car audio device by the microphones 3A and 3B for detecting vehicle interior noise. That is, transmission channels through which the sounds acoustically outputted from the speakers 82A and 82B transmit until they are entered into the microphones 3A and 3B are simulated first, and filtering processes corresponding to the transmission characteristics of the transmission channels are performed on the audio signals AUD₁ and AUD₂ reproduced or demodulated by the car audio device 9. As a result, the audio signal components M₁₁, M₁₂, M₂₁, and M₂₂ leaked into the car interior noise signals CNQ₁ and CNQ₂ detected by the microphones 3A and 3B are obtained. Then, the antiphase car interior noise signals CT₁ and CT₂ are generated by removing the audio signal components M₁₁, M₁₂, M₂₁, and M₂₂ from the car interior noise signals CNQ₁ and CNQ₂.

As described above, in the noise cancelling control unit 4 shown in FIG. 9, the audio signal components leaked into the car interior noise signals detected by the microphones are obtained with a transfer function based on the audio signals reproduced by the car audio device, and the audio signal components are removed from the car interior noise signals.

In the above-described first embodiment, since reproduced sound from a car audio device is also detected by the microphones in a case where the car audio device is being used simultaneously, the reproduced sound is mixed into the car interior noise. However, the first embodiment is configured to remove the reproduced sound with the equalizers (EQ) 11 and 14 and perform noise cancel only on the noise component (feedback type).

The second embodiment employs a feedforward configuration such that the audio signal components of the car audio device to be detected by the microphones are obtained before the reproduced sound enters into the microphones, and the audio signal components are removed from the car interior noise signals detected by the microphones so as to perform cancelling only on the noise components. Therefore, since a phase shift amount involved with a delay is reduced as compared to the feedback type, it becomes possible to perform noise cancel more accurately.

Also in the noise cancelling control unit 4 shown in FIG. 9, the controller 20 executes the noise cancelling control process shown in FIG. 6 as with that shown in FIG. 4, and if the detected vehicle exterior sound is predetermined specific sound, or if the approach of an emergency vehicle emitting specific sound is detected, the noise cancelling operation is reduced or disabled automatically over the duration of such detection.

Alternatively, in step S7 shown in FIG. 6, the noise cancelling operation may be continuously enabled without disabling the noise cancelling operation completely. That is, the controller 20 may be configured to perform an adjustment for reducing a noise cancelling amount to the extent that the driver can hear emergency vehicles sirens (specific sounds).

According to the present embodiment, since it is configured so that noise cancel is disabled or a noise cancelling amount is reduced when specific sound is detected, the sound of the car audio device 9 is not interrupted even when the specific sound is detected. That is, without interrupting the sound of the car audio device 9, the exterior sound which previously had been reduced or made inaudible by the noise cancelling effect is allowed to have a normal audible volume in response to the detection of warning sound (specific sound). Therefore, with no concern for the interruption of the sound such as music outputted from the car audio device 9, the approach of an emergency vehicle or the like can be recognized while listening to the audio outputs of the car audio device 9. Furthermore, there occurs no phenomenon unpleasant to a driver, such as the sound interruption due to false detection occurring when the volume of warning sound is small.

Moreover, since the feedforward configuration is employed, a phase shift amount involved with a delay is reduced as compared to a case where the feedback configuration is employed. As a result, noise cancel can be performed in a broader frequency range.

### Third Embodiment

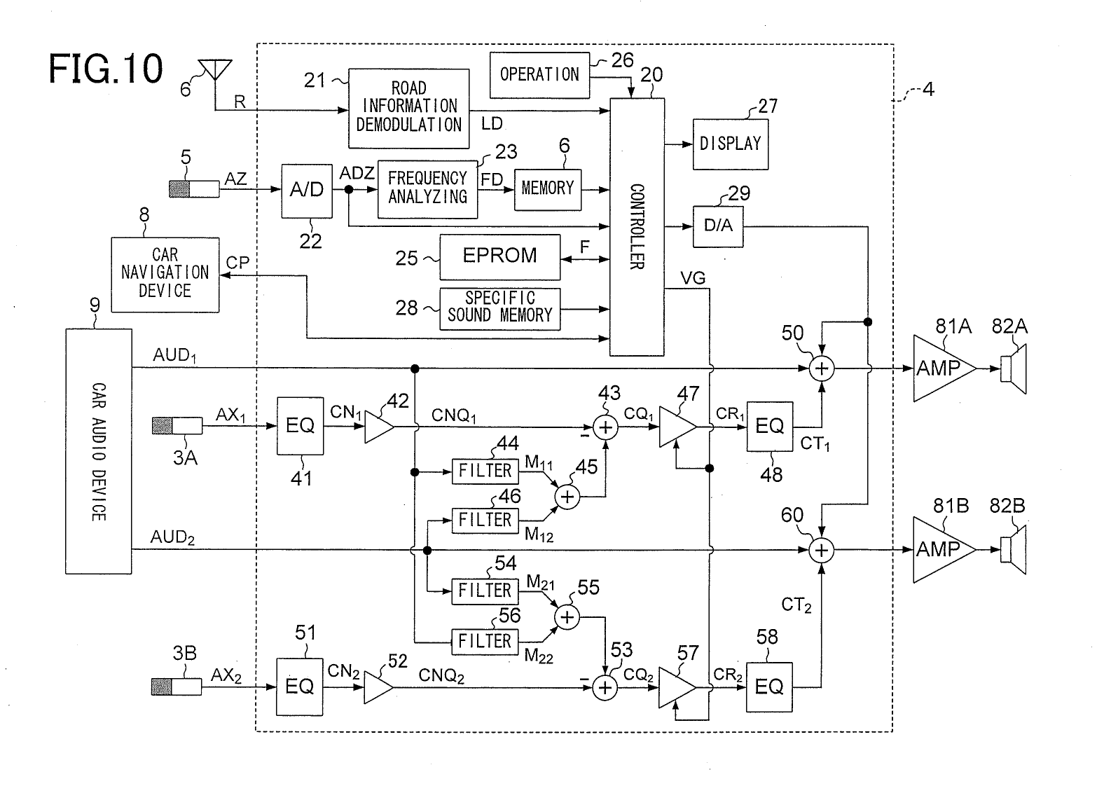

FIG. 10 is a block diagram showing a configuration of a noise cancelling control unit 4 according to the third embodiment. Specifically, the present embodiment is configured so that if it is detected that the detected vehicle exterior sound is predetermined specific sound or if the approach of an emergency vehicle emitting specific sound is detected, the specific sound is acoustically outputted from the speakers 7A, 7B, 82A, and 82B in the noise cancelling control unit 4 of the above-described first or second embodiment (FIG. 4 or FIG. 9).

The configuration of the noise cancelling control unit 4 shown in FIG. 10 is the same as that shown in FIG. 9 except that a specific sound memory 28 and a D/A converter 29 are added to the configuration shown in FIG. 9 and adders 50 and 60 are employed instead of the adders 49 and 59 shown in FIG. 9. Thus, operations of the specific sound memory 28, the D/A converter 29, and the adders 49 and 59 will be mainly described below.

The specific sound memory 28 shown in FIG. 10 stores specific sound waveform data corresponding to the specific sound frequency data F stored in the EPROM 25 for each of the specific sounds. For example, sirens of a police car, an ambulance, and a fire truck are digitally recorded in advance in the specific sound memory 28 only for a predetermined period of time in association with the respective emergency vehicles. If it is determined in step S4 or S6 shown in FIG. 6 that an emergency vehicles siren has been emitted or there exists an emergency vehicle approaching one's own car, the controller 20 reads out the siren for the predetermined period of time corresponding to the emergency vehicle from the specific sound memory 28, and repeatedly provides it to the D/A converter 29. The D/A converter 29 converts the siren read out from the specific sound memory 28 to an analog audio signal, and provides it to the adders 50 and 60. The adders 50 and 60 provide, to the amplifiers 81A and 81B, the sum of the audio signals AUD₁ and AUD₁ provided by the car audio device 9, the antiphase car interior noise signals CT₁ and CT₂, and the siren audio signal as described above. Thus, if it is determined that an emergency vehicles siren has been emitted or there exists an emergency vehicle approaching one's own car (step S4 or S6), the emergency vehicles siren recorded in the specific sound memory 28 is acoustically outputted to the vehicle interior. Therefore, the driver can recognize the approach of the emergency vehicle more reliably.

Although the emergency vehicles siren recorded in the specific sound memory 28 is acoustically outputted to the car interior in this embodiment, an emergency vehicles siren detected by the external microphone may be forced to be acoustically outputted to the vehicle interior. That is, if it is determined in step S4 or S6 of FIG. 6 that an emergency vehicles siren has been emitted or there exists an emergency vehicle approaching one's own car, the controller 20 extracts the emergency vehicles siren from within the car exterior signal ADZ detected by the external microphone, and provides it to the adders 50 and 60 via the D/A converter 29. Here, the controller 20 preferably provides sound obtained by shifting the phase of the emergency vehicles siren detected by the external microphone to the adders 50 and 60 via the D/A converter 29, thereby suppressing a reduction in siren sound level in terms of hearing.

Alternatively, in a case where warning sound (specific sound) such as an emergency vehicles siren is acoustically outputted to the vehicle interior as described above, the noise cancelling operation may be continuously enabled without executing step S7 shown in FIG. 6. In this case, the noise cancelling amount may be adjusted in conformity with the volume of the warning sound to be acoustically outputted to the vehicle interior. That is, the controller 20 executes control for reducing the noise cancelling amount, instead of step S7 shown in FIG. 6, by providing, to the variable gain amplifiers 47 and 57, the gain specification signal VG that specifies a smaller gain as the specific sound volume decreases. According to such control, it becomes possible to constantly enable the noise cancelling operation to the extent that a driver can hear an emergency vehicles warning sound (specific sound).

As with the second embodiment, it is possible also in the present embodiment to recognize the approach of an emergency vehicle or the like without interrupting the sound of the car audio device 9 even when specific sound is detected. Furthermore, there occurs no phenomenon unpleasant to a driver, such as the sound interruption due to false detection occurring when the volume of warning sound is small.

Moreover, although the operation of the noise-reduction device according to the present invention when installed in a vehicle has been described by way of example in the above-described embodiments, the present invention can be applied also to movable bodies other than cars (ships, trains, airplanes, or the like, for example). In short, if the emission of specific sound required as a driving index for a movable body is detected outside the movable body, the noise-reduction device according to the present invention reduces a noise cancelling amount (or makes it zero) when cancelling noise leaked into the room interior of the movable body over the duration of such detection.

As described above in detail, according to the present invention, if specific sound such as emergency vehicles warning sound is detected, the noise cancelling operation is automatically disabled or an adjustment to reduce the noise cancelling amount is performed to the extent that a driver can hear the specific sound. Thus, the driver can hear the specific sound clearly. Moreover, since it is possible to hear the specific sound clearly while maintaining the volume of the car audio device or the like in operation inside the vehicle, there is no need to perform a bothering operation such as lowering the volume of the car audio device in order to make it easier to hear the specific sound. Also, there is no need to halt a conversation inside the vehicle. Furthermore, according to the noise-reduction device of the present invention, since an operation such as reducing the volume of the audio device is not performed even when specific sound is detected, there occurs no unpleasant phenomenon such as the sound interruption. Thus, it is possible to recognize the approach of an emergency vehicle or the like successfully.

### REFERENCE SIGNS LIST

3A, 3B room microphone

5 external microphone

7A, 7B speaker

8 car navigation device

9 audio device

11, 14 equalizer

12, 15 variable gain inversion amplifier

20 controller

23 frequency analyzing unit

25 EPROM

1. A noise-reduction device for reducing noise in room interior of a movable body, comprising:
a noise cancelling unit for acoustically outputting sound having a phase opposite to that of a main component of the noise to the room interior of the movable body so as to cancel the noise;
a specific sound determination unit for determining whether or not predetermined specific sound has been emitted outside the movable body; and
a control unit for reducing a noise cancelling amount in said noise cancelling unit in a case where it is determined in said specific sound determination unit that the specific sound has been emitted,
wherein said specific sound determination unit includes on the movable body an external microphone that detects exterior sound of the movable body, and
wherein said control unit controls said noise cancelling amount at said noise cancelling unit in conformity with a sound level detected by said external microphone.

2. (canceled)

3. The noise-reduction device according to claim 1, wherein said control unit reduces said noise cancelling amount as the sound level detected by said external microphone decreases.

4. The noise-reduction device according to claim 1, wherein said specific sound determination unit comprises:
a memory that stores specific sound frequency data representing a frequency spectrum of the specific sound;
an external microphone that detects exterior sound of the movable body to obtain a movable body exterior sound signal; and
a determination unit that determines that the specific sound has been emitted if a similarity between a frequency spectrum in said movable body exterior sound signal and the frequency spectrum represented by said specific sound frequency data stored in said memory is greater than a predetermined value.

5. The noise-reduction device according to claim 4, wherein said specific sound determination unit further comprises means for receiving wirelessly-transmitted positional information indicating a position at which the specific sound is originated, and
said specific sound determination unit determines that the specific sound has been emitted also when a distance between the position indicated by said positional information at which the specific sound is originated and a current position of the movable body is smaller than a predetermined distance.

6. The noise-reduction device according to claim 4, wherein the external microphone is installed at a position spaced apart from a power source of the movable body with a predetermined distance or more.

7. The noise-reduction device according to claim 1, wherein
said noise cancelling unit includes: a room microphone that detects room interior sound of the movable body to obtain a movable body interior sound signal; a noise component extracting unit that extracts a signal component in a frequency band of the noise from within said movable body interior sound signal to obtain it as a noise signal; a variable gain amplifier that amplifies a signal obtained by inverting a polarity of said noise signal to obtain it as an antiphase noise signal; and a speaker that acoustically outputs sound based on said antiphase noise signal, and
said control unit reduces an amplification gain of said variable gain amplifier when it is determined that the specific sound has been emitted.

8. The noise-reduction device according to claim 1, wherein the specific sound is an emergency vehicles siren or railroad crossing sound.

9. The noise-reduction device according to claim 1, comprising an audio device that receives broadcast waves or reproduces recorded information from a recording medium to obtain an audio signal, wherein
said noise cancelling unit acoustically outputs sound obtained by superimposing sound having a phase opposite to that of the noise on sound based on said audio signal.

10. The noise-reduction device according to claim 4, wherein
said noise cancelling unit includes: a room microphone that detects room interior sound of the movable body to obtain a movable body interior sound signal; a noise component extracting unit that extracts a signal component in a frequency band of the noise from within said movable body interior sound signal to obtain it as a noise signal; a variable gain amplifier that amplifies a signal obtained by inverting a polarity of said noise signal to obtain it as an antiphase noise signal; and a speaker that acoustically outputs sound based on said antiphase noise signal, and
said control unit reduces an amplification gain of said variable gain amplifier when it is determined that the specific sound has been emitted.

11. The noise-reduction device according to claim 5, wherein
said noise cancelling unit includes: a room microphone that detects room interior sound of the movable body to obtain a movable body interior sound signal; a noise component extracting unit that extracts a signal component in a frequency band of the noise from within said movable body interior sound signal to obtain it as a noise signal; a variable gain amplifier that amplifies a signal obtained by inverting a polarity of said noise signal to obtain it as an antiphase noise signal; and a speaker that acoustically outputs sound based on said antiphase noise signal, and
said control unit reduces an amplification gain of said variable gain amplifier when it is determined that the specific sound has been emitted.

12. The noise-reduction device according to claim 4, wherein the specific sound is an emergency vehicles siren or railroad crossing sound.

13. The noise-reduction device according to claim 5, wherein the specific sound is an emergency vehicles siren or railroad crossing sound.

14. The noise-reduction device according to claim 4, comprising an audio device that receives broadcast waves or reproduces recorded information from a recording medium to obtain an audio signal, wherein
said noise cancelling unit acoustically outputs sound obtained by superimposing sound having a phase opposite to that of the noise on sound based on said audio signal.

15. The noise-reduction device according to claim 5, comprising an audio device that receives broadcast waves or reproduces recorded information from a recording medium to obtain an audio signal, wherein
said noise cancelling unit acoustically outputs sound obtained by superimposing sound having a phase opposite to that of the noise on sound based on said audio signal.

16. The noise-reduction device according to claim 7, comprising an audio device that receives broadcast waves or reproduces recorded information from a recording medium to obtain an audio signal, wherein
said noise cancelling unit acoustically outputs sound obtained by superimposing sound having a phase opposite to that of the noise on sound based on said audio signal.

17. The noise-reduction device according to claim 8, comprising an audio device that receives broadcast waves or reproduces recorded information from a recording medium to obtain an audio signal, wherein
said noise cancelling unit acoustically outputs sound obtained by superimposing sound having a phase opposite to that of the noise on sound based on said audio signal.

18. The noise-reduction device according to claim 10, comprising an audio device that receives broadcast waves or reproduces recorded information from a recording medium to obtain an audio signal, wherein
said noise cancelling unit acoustically outputs sound obtained by superimposing sound having a phase opposite to that of the noise on sound based on said audio signal.

19. The noise-reduction device according to claim 11, comprising an audio device that receives broadcast waves or reproduces recorded information from a recording medium to obtain an audio signal, wherein
said noise cancelling unit acoustically outputs sound obtained by superimposing sound having a phase opposite to that of the noise on sound based on said audio signal.

20. The noise-reduction device according to claim 12, comprising an audio device that receives broadcast waves or reproduces recorded information from a recording medium to obtain an audio signal, wherein
said noise cancelling unit acoustically outputs sound obtained by superimposing sound having a phase opposite to that of the noise on sound based on said audio signal.

21. The noise-reduction device according to claim 13, comprising an audio device that receives broadcast waves or reproduces recorded information from a recording medium to obtain an audio signal, wherein
said noise cancelling unit acoustically outputs sound obtained by superimposing sound having a phase opposite to that of the noise on sound based on said audio signal.
